(19) United States
(12) Patent Application Publication
(10) Pub. No.: US 2010/0015391 A1
(43) Pub. Date: Jan. 21, 2010

(54) COMPOSITE ARTICLE, A PROCESS FOR ITS MANUFACTURE AND USE

(76) Inventors: Jean Hubert Marie Beugels, Landgraaf (NL); David Vanek, Charlotte, NC (US); Johann Van Elburg, Landgraaf (NL); Alexander Volker Peters, Aachen (DE); Steen Tanderup, Maastricht (NL)

Correspondence Address: NIXON & VANDERHYE, PC, 901 NORTH GLEBE ROAD, 11TH FLOOR, ARLINGTON, VA, 22203, US

(21) Appl. No.: 12/298,402

(22) PCT Filed: Apr. 25, 2007
(86) PCT No.: PCT/EP2007/003633

§ 371 Date: Apr. 22, 2009

(30) Foreign Application Priority Data
Apr. 26, 2006 (EP) 06008600.6
Jun. 29, 2006 (EP) 06013452.5

(51) Int. Cl. B32B 5/12

(52) U.S. Cl. 428/113; 156/308.2

(57) ABSTRACT

The invention relates to a composite article comprising a metal sheet of at least 0.25 mm thickness and at least two unidirectional sheets, with the metal in the metal sheet having a melting point of at least 350° C., whereby the unidirectional sheets comprise at least 2 mono-layers of unidirectional oriented high performance fibers, with the direction of the said fibers in a mono-layer is at an angle α to the direction of the fibers in an adjacent mono-layer.

The invention furthermore relates to a process for the manufacture of a composite article and the use of the composite article in buildings and constructions, vehicles, and ballistic applications, especially under conditions of heat and fire.

The present invention relates to a composite article, a process for its manufacture and the use of the composite article.

The composite article according to the invention comprises a metal sheet and at least two unidirectional sheets.

Composite articles according to the invention are very suitable for use in buildings and constructions, vehicles, and ballistic applications, especially under conditions of heat and fire. In a special embodiment, the composite articles according to the invention are flame retardant.

A composite article comprising a metal sheet and at least two unidirectional sheets is known from WO 2004/033196 A2. This publication discloses a composite article comprising at least 3 plies, whereby a first ply is a metal foil, preferably an aluminum foil, of a thickness between 12.7 and 127 micrometer, a second ply is a bonding material and a third ply comprises a plurality of layers of a network of polymeric fibers in a matrix. The disclosed bonding material is either intrinsically fire resistant or is made by admixture with a additive, such as e.g. additives based on phosphorous and/or nitrogen and/or halogens as bromine and chlorine and/or inorganic additives as e.g. antimony oxide and antimony sulphide. Example 1 of WO 2004/033196 A2 discloses a composite article consisting of a 7 ply symmetrical construction with an aluminum foil of 76 micrometer as ply #1 and ply # 7; a resinous composition of an intumescent epoxy resin and glass bubbles as ply #2 and ply # 6; a pressure sensitive film adhesive comprised of a blend of antimony oxide (Sb₂O₃), decabromo diphenyl ether and polychlorinated paraffin wax in an acrylate ester resin as ply #3 and ply # 5; and finally a central ply #4 consisting of 50 layers of unidirectionally aligned high strength polyethylene fibers in an epoxy vinyl ester binder, whereby the polyethylene fibers in adjacent layers are oriented at 90° to one another.

Disadvantage of the composite article according to WO 2004/033196 A2 is that use is made of flame retardant additives that comprise halogens or heavy metals. During heat, and especially during fire, these flame retardant additives generate highly toxic and/or corrosive gasses. Such gases are very harmful to human beings. Furthermore such corrosive gasses are detrimental to e.g. high tech electronic equipment in vehicles as e.g. airplanes and boats.

Object of the invention is to provide a composite article which comprises a reduced amount of halogenated flame retardant additives or which does not make use of halogenated flame retardant additives at all.

This object is achieved with the composite article according to the invention, whereby the composite article comprising a metal sheet and at least two unidirectional sheets, whereby the thickness of the metal sheet is at least 0.25 mm, with the metal in the metal sheet having a melting point of at least 350° C., whereby the unidirectional sheets comprise at least 2 mono-layers of unidirectional oriented high performance fibers and optionally a binder, with the direction of the said fibers in a monolayer sheet is at an angle α to the direction of the fibers in an adjacent monolayer sheet. The metal sheet and the unidirectional sheets are preferably sufficiently interconnected to each other, meaning that the metal sheet and the unidirectional sheets do not delaminate under normal use conditions such as e.g. at room temperature. Conditions of normal use do not include testing of fire retardant performance and testing under increased temperature, so called accelerated testing.

An additional advantage of the present invention is that it provides a composite article with much simpler construction with fewer layers than the construction disclosed in WO 2004/033196 A2.

Preferably the composite article according to the invention is flame retardant as can be judged by the fact that these articles pass the flammability temperature flame retardant test according to ISO 4589-3. In this application passing of the flame retardant test according to ISO 4589-3 means that the composite article reaches a flammability temperature of at least 200° C. in said test. Alternatively, or in addition to, the composite article according to the invention passes the International Maritime Organisation (IMO) Fire Test Procedure (FTP) Codes 1998, Part 2 Smoke and toxicity test, including revision MSC/Circ. 1008 and the IMO FTP Resolution A.653(16) evaluated in accordance to Part 5 of Annex 1 of the IMO FTP Code for bulkhead, wall and ceiling linings.

The composite article according to the invention comprises a metal layer. It is essential that the metal in the metal sheet has a melting point of at least 350° C., more preferably at least 500° C., most preferably at least 600° C. Suitable metals include aluminum, magnesium, titanium, copper, nickel, chromium, beryllium, iron and copper including their alloys as e.g. steel and stainless steel and alloys of aluminum with magnesium (so-called aluminum 5000 series), and alloys of aluminum with zinc and magnesium or with zinc, magnesium and copper (so-called aluminum 7000 series). In said alloys the amount of e.g. aluminum, magnesium, titanium and iron preferably is at least 50 wt %. Preferred metals sheets comprising aluminum, magnesium, titanium, nickel, chromium, beryllium, iron including their alloys. More preferably the metal sheet is based on aluminum, magnesium, titanium, nickel, chromium, iron and their alloys. This results in a light composite article with a good durability. Even more preferably the iron and its alloys in the metal sheet have a Brinell hardness of at least 500. Most preferably the metal sheet is based on aluminum, magnesium, titanium, and their alloys. This results in the lightest composite article with the highest durability. Durability in this application means the lifetime of a composite under conditions of exposure to heat, moisture, light and UV radiation.

For the composite article according to the invention it is essential that the thickness of the metal sheet is at least 0.25 mm. More preferably the thickness of the metal sheet is at least 0.5 mm. This results in a good flame retardant performance. Most preferably the thickness of the metal sheet is at least 0.75 mm. This results in an even better flame retardant performance. Regarding the thickness of the metal sheet, there is no limitation to a maximum thickness. Generally a maximum thickness of 50 mm will be chosen, higher thicknesses only have limited additional improvement on flame retardant performance. Preferably the maximum thickness of the metal layer is 40 mm, more preferably the maximum thickness of the metal layer is 30 mm. This results in the best balance between weight and flame retardant performance. In the case that, in addition to flame retardant performance, also an improved ballistic performance is required, a thicker metal sheet is beneficial for the ballistic performance of the composite article according to the invention. In such case the minimum thickness is preferably 5 mm. The maximum thickness of the metal sheet in such a case can be determined by the required level of ballistic performance and can be verified by routine experimentation, but is generally less than 50 mm.

The metal sheet may optionally be pretreated in order to improve adhesion with a unidirectional sheet. Suitable pretreatment of the metal sheet includes mechanical treatment e.g. to roughen or clean the metal surface with sanding or grinding, chemical etching with e.g. nitric acid and laminating with polyethylene film. In another embodiment a bonding layer, e.g. glue, between the metal sheet and the unidirectional sheet may be applied. Such glue may comprise an epoxy resin, a polyester resin, a polyurethane resin or a vinylester resin. In the event that the high performance fiber in the monolayer of unidirectional oriented fibers is an organic fiber, the bonding layer may further comprise a layer of an inorganic fiber in a woven or non-woven fashion. Preferably the inorganic fiber in the bonding layer is woven. The weight of the layer of inorganic fiber in woven or non-woven fashion may range from 50 to 750 g/m², preferably from 100 to 500 g/m². Preferably such inorganic fiber is a glass fiber or a carbon fiber. More preferably such inorganic fiber is a glass fiber including E-glass and high strength glass (sometimes also referred to as ‘S’-glass). Such layer improves energy transfer from metal to the monolayer of unidirectional oriented organic fibers.

In a special embodiment the metal sheet may be attached to the at least two unidirectional sheet by mechanical means as e.g. screws, bolts and snap fits.

In the composite article according to the invention the metal sheet faces a unidirectional sheet. If required, e.g. for stiffness reasons, the at least 2 unidirectional sheets may be sandwiched between 2 metal sheets. Type of each of these 2 metal sheets and their thicknesses may be chosen independently from the ranges given above.

The composite article according to the invention comprises unidirectional sheets. These unidirectional sheets—which also may be referred as unidirectional layers—comprise mono-layers of unidirectional oriented high performance fibers and a binder. The term mono-layer of unidirectional high performance fibers refers to a layer of unidirectionally oriented high performance fibers i.e. high performance fibers in one plane that are essentially oriented in parallel.

The composite article according to the invention comprises at least 2 unidirectional sheets, preferably at least 40 unidirectional sheets, more preferably at least 80 unidirectional sheets, even more preferably at least 120 unidirectional sheets and most preferably at least 160 unidirectional sheets. The direction of the fibers in a unidirectional sheet is at an angle α to the direction of the fibers in an adjacent unidirectional sheet. The angle α is preferably between 5 and 90°, more preferably between 45 and 90° and most preferably between 75 and 90°.

The term high performance fiber comprises not only a monofilament but, inter alia, also a multifilament yarn or a flat tape. Width of the flat tape preferably is between 2 mm and 100 mm, more preferably between 5 mm and 60 mm, most preferably between 10 mm and 40 mm. Thickness of the flat tape preferably is between 10 μm and 200 μm, more preferably between 25 μm and 100 μm.

Preferably the term high performance fiber comprises a monofilament and a multifilament yarn. Preferably the fineness per filament of the high performance fiber is less than 5 denier per filament (dpf), more preferably less than less than 3 dpf, even more preferably less than 2 dpf and most preferably less than 1.5 dpf. This result in composite articles that can be very suitable be applied in ballistic applications, while furthermore showing good resistance against fire.

The high performance fibers in the composite article according to the invention have a tensile strength of at least about 1.2 GPa and a tensile modulus of at least 40 GPa. These fibers preferably have a tensile strength of at least 2 GPa, more preferably at least 2.5 GPa or most preferably at least 3 GPa. The advantage of these fibers is that they have very high tensile strength, so that they are in particular very suitable for use in e.g. lightweight and strong articles. The high performance fibers may be inorganic or organic fibers.

Suitable inorganic fibers are, for example, glass fibers, carbon fibers and ceramic fibers.

Suitable organic fibers with such a high tensile strength are, for example, aromatic polyamide fibers (generally referred to as aramid fibers), especially poly(p-phenylene terephthalamide), liquid crystalline polymer and ladder-like polymer fibers such as polybenzimidazoles or polybenzoxazoles, esp. poly(1,4-phenylene-2,6-benzobisoxazole) (PBO), or poly(2,6-diimidazo[4,5-b-4′,5′-e]pyridinylene-1,4-(2,5-dihydroxy)phenylene) (PIPD; also referred to as M5) and fibers of, for example, polyolefins as e.g. polyethylene and polypropylene, polyvinyl alcohol, and polyacrylonitrile which are highly oriented, such as obtained, for example, by a gel spinning process.

More preferably aromatic polyamide fibers, especially poly(p-phenylene terephthalamide), liquid crystalline polymer and ladder-like polymer fibers such as polybenzimidazoles or polybenzoxazoles, especially poly(1,4-phenylene-2,6-benzobisoxazole) or poly(2,6-diimidazo[4,5-b-4′,5′-e]pyridinylene-1,4-(2,5-dihydroxy)phenylene) and ultra high molecular weight polyethylene are used as high performance fiber. These fibers give a good balance between strength and fire retardant performance. Even more preferably gel spun polyethylene is used as high performance fiber. In such case preferably linear polyethylene is used. Linear polyethylene is herein understood to mean polyethylene with less than 1 side chain per 100 C atoms, and preferably with less than 1 side chain per 300 C atoms; a side chain or branch generally containing at least 10 C atoms. Side chains may suitably be measured by FTIR on a 2 mm thick compression moulded film, as mentioned in e.g. EP 0269151. The linear polyethylene may further contain up to 5 mol % of one or more other alkenes that are copolymerisable therewith, such as propene, butene, pentene, 4-methylpentene, octene. Preferably, the linear polyethylene is of high molar mass with an intrinsic viscosity (IV, as determined on solutions in decalin at 135° C.) of at least 4 dl/g; more preferably of at least 8 dl/g, most preferably of at least 10 dl/g. Such polyethylene is also referred to as ultra-high molar mass polyethylene. Intrinsic viscosity is a measure for molecular weight that can more easily be determined than actual molar mass parameters like Mₙ and M_{w}. There are several empirical relations between IV and M_{w}, but such relation is highly dependent on molecular weight distribution. Based on the equation M_{w}=5.37×10⁴ [IV]^{1.37} (see EP 0504954 A1) an IV of 4 or 8 dl/g would be equivalent to M_{w} of about 360 or 930 kg/mol, respectively. This polyethylene fiber gives the lowest amount of toxic and corrosive gasses upon exposure to heat or fire.

The weight of the high performance fiber in the unidirectional sheet preferably ranges form 5 to 250 g/m², more preferably ranges form 10 to 200 g/m², most preferably ranges form 20 to 150 g/m².

The term binder refers to a material that binds or holds the high performance fibers together in the unidirectional sheet, the binder may enclose the high performance fibers in their entirety or in part, such that the structure of the mono-layer is retained during handling and making of unidirectional sheets. The binder may be applied in various forms and ways; for example as a film (by melting hereof at least partially covering the anti ballistic fibers), as a transverse bonding strip or as transverse fibers (transverse with respect to unidirectional fibers), or by impregnating and/or embedding the fibers with a matrix material, e.g. with a polymer melt, a solution or a dispersion of a polymeric material in a liquid. Preferably, matrix material is homogeneously distributed over the entire surface of the mono-layer, whereas a bonding strip or bonding fibers may be applied locally. Suitable binders are described in e.g. EP 0191306 B1, EP 1170925 A1, EP 0683374 B1 and EP 1144740 A1. It will be appreciated that, in embodiments in which the high performance fiber is a flat tape, the application of a binder may not be required. More specifically, a binder may not be required if the process of producing the at least two unidirectional sheets enables the structure of the mono-layer to be sufficiently retained without the application of a binder, such as the structure of a mono-layer formed from flat tape.

In a preferred embodiment, the binder is a polymeric matrix material, and may be a thermosetting material or a thermoplastic material, or mixtures of the two. The elongation at break of the matrix material is preferably greater than the elongation of the fibers. The binder preferably has an elongation of 2 to 600%, more preferably an elongation of 4 to 500%. Suitable thermosetting and thermoplastic matrix materials are enumerated in, for example, WO 91/12136 A1 (pages 15-21). In the case the matrix material is a thermosetting polymer vinyl esters, unsaturated polyesters, epoxies or phenol resins are preferably selected as matrix material. In the case the matrix material is a thermoplastic polymer polyurethanes, polyvinyls, polyacrylics, polyolefins or thermoplastic elastomeric block copolymers such as polyisopropene-polyethylene-butylene-polystyrene or polystyrene-polyisoprene-polystyrene block copolymers are preferably selected as matrix material. Preferably the binder consists of a thermoplastic polymer, which binder preferably completely coats the individual filaments of said fibers in a mono-layer, and which binder has a tensile modulus (determined in accordance with ASTM D638, at 25° C.) of at least 250 MPa, more preferably of at least 400 MPa. Such a binder results in high stiffness of a unidirectional sheet.

The amount of binder in the unidirectional sheet is preferably at most 30 mass %, more preferably at most 25, 20, or even more preferably at most 15 mass %. This results in the best flame retardant performance.

The composite article according to the invention has preferably a weight, in this application also referred to as areal density, of at least 4.0 kg/m², more preferably of at least 6.0 kg/m², most preferably of at least 8.0 kg/m².

The unidirectional sheet in the composite article according to the invention has preferably an areal density of at least 2.0 kg/m², more preferably of at least 4.0 kg/m², most preferably of at least 6.0 kg/m².

The composite article according to the invention may suitably be used in ballistic applications. Ballistic applications comprise applications with ballistic threat against bullets of several kinds including against armor piercing, so-called AP, bullets and hard particles such as e.g. fragments and shrapnel.

In the event that the composite article according to the invention is used in ballistic applications where a threat against AP bullets may be encountered the metal sheet preferably faces a ceramic layer. In this way an article is obtained with a layered structure as follows: ceramic layer/metal sheet/at least two unidirectional sheets with the direction of the fibers in the unidirectional sheet at an angle α to the direction of the fibers in an adjacent unidirectional sheet. Suitable ceramic materials include e.g. alumina oxide, titanium oxide, silicium oxide, silicium carbide and boron carbide. The thickness of the ceramic layer depends on the level of ballistic threat but generally varies between 2 mm and 30 mm. This composite article will be positioned preferably such that the ceramic layer faces the ballistic threat.

The invention furthermore relates to a process for producing the composite article, comprising the steps of:
stacking of at least 2 unidirectional sheets whereby the direction of the high performance fiber in a unidirectional sheet is at an angle α to the fiber direction in an adjacent unidirectional sheet, and a metal sheet of thickness of at least 0.25 mm and a melting point of at least 350° C. followed by
consolidating the stacked sheets under temperature and pressure.
   Consolidating may suitably be done in a hydraulic press.

The temperature during consolidating generally is controlled through the temperature of the press. A minimum temperature generally is chosen such that a reasonable speed of consolidation is obtained. In this respect 50° C. is a suitable lower temperature limit, preferably this lower limit is at least 75° C., more preferably at least 95° C., most preferably at least 115° C. A maximum temperature is chosen below the temperature at which the high performance fiber loses its high mechanical properties due to e.g. melting. Preferably the temperature is at least 10° C., preferably at least 15° C. and even more at least 20° C. below the melting temperature of the fiber. In case the fiber does not exhibit a clear melting temperature, the temperature at which the fiber starts to lose its mechanical properties should be read instead of melting temperature. In the case of e.g. HPPE fibers, often having a melting temperature of 155 C, a temperature below 135° C. generally will be chosen.

The pressure during consolidating preferably is at least 7 MPa, more preferably at least 10 MPa, even more preferably at least 13 MPa and most preferably at least 16 MPa. In this way a stiff composite article is obtained.

The optimum time for consolidation generally ranges from 5 to 120 minutes, depending on conditions such as temperature, pressure and part thickness and can be verified through routine experimentation.

In the event that curved composite articles are to be produced it may be advantageous to first pre-shape the metal sheet into the desired shape, followed by consolidating with the unidirectional sheets.

The composite article according to the invention is very suitable for use in buildings and constructions, e.g. as cladding, in vehicles for land, air and sea including e.g. boats and airplanes, and in ballistic applications, especially under conditions of heat and fire.

Test methods as referred to in the present application, are as follows
Intrinsic Viscosity (IV) is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration;
Tensile properties (measured at 25° C.): tensile strength (or strength), tensile modulus (or modulus) and elongation at break (or eab) are defined and determined on multifilament yarns as specified in ASTM D885M, using a nominal gauge length of the fiber of 500 mm, a crosshead speed of 50%/min. On the basis of the measured stress-strain curve the modulus is determined as the gradient between 0.3 and 1% strain. For calculation of the modulus and strength, the tensile forces measured are divided by the titre, as determined by weighing 10 metres of fiber; values in GPa are calculated assuming a density of 0.97 g/cm³. Tensile properties of thin films were measured in accordance with ISO 1184(H).Flammability temperature: is a flame retardant test according to the ISO 4589-3 standard whereby the temperature is determined at which a small vertical test specimen of prescribed dimensions, subjected to a defined flame stops to burn in air with 20.9 vol. % of oxygen. The test is conducted whereby the metal sheet faces the flame. If the flammability temperature is above 200° C., the sample is said to ‘PASS’ the test.
Toxicity index: is determined according to the NES713 standard, whereby in a toxicity test box about 1 gram (10*10*4 mm) of material has to be completely burned at 1100° C. with a flame in a box with a volume of nearly 1 m³. After combustion gasses are analyzed and the result is expressed as a toxicity index. If the index is below a value of 5, the sample is said to ‘PASS’ the test.
Smoke index: is determined according to the NES711 standard, whereby a sample of prescribed dimensions is placed vertical in front of a heat source The test is conducted whereby the metal sheet faces the heat source. Smoke is analyzed and the result is expressed as a smoke index. If the index is below a value of 50, the sample is said to ‘PASS’ the test.
Fire retardant properties were tested according to International Maritime Organisation (IMO) Fire Test Procedure (FTP) Codes 1998, Part 2 Smoke and toxicity test, including revision MSC/Circ. 1008; IMO FTP Resolution A.653(16) evaluated in accordance to Part 5 of Annex 1 of the IMO FTP Code for bulkhead, wall and ceiling linings and ISO 4589-3.

The invention is explained with reference to the following comparative experiment and examples, without however being limited thereto.

### Unidirectional Sheet

As unidirectional sheet, a sheet was used with 2 mono-layers of unidirectional oriented polyethylene fibers and a binder with the direction of the polyethylene fibers in a mono layer is at an angle of 90 degrees to the direction of the polyethylene fibers in an adjacent mono layer. The polyethylene fibers are highly-drawn fibers of high molar mass linear polyethylene, Dyneema® SK76 of DSM Dyneema-Netherlands, with a strength of 36 cN/dtex, a modulus of 1180 cN/dtex and a fineness of 2 denier per filament.

In addition to the polyethylene fibers, the monolayer contained 18 weight % of binder consisting of a polyurethane based on polyetherdiol and aliphatic di-isocyanate.

The areal density of the unidirectional sheet was 130.5 g/m².

### Procedure for Compressing Unidirectional Sheets:

A number of the above-mentioned unidirectional sheets were stacked to yield a package whereupon the package in its entirety was placed between two platens of a standard press. The temperature of the platens was between 125-130° C. The package was retained in the press until the temperature at the centre of the package was 115-125° C. Subsequently, the pressure was increased to a compressive pressure of 30 MPa and the package was kept under this pressure for 65 min. Subsequently the package was cooled to a temperature of 60° C. at the same compressive pressure.

### Comparative Experiment A

A number of 390 unidirectional sheets comprising polyethylene fibers were stacked and pressed according the procedure for compressing unidirectional sheets as described above. A surface of the obtained compressed stack of unidirectional sheets was mechanically treated with sandpaper. A sheet of aluminium 7039A of thickness 0.15 mm was taken and also mechanically treated with sandpaper. The sheet of aluminium 7039A was glued onto the mechanically treated surface of the compressed stack of unidirectional sheets with Sikaflex® 252; subsequently the sheet of aluminium 7039A and compressed stack of unidirectional sheets was put into the standard press at room temperature and during 30 minutes a pressure of 10 MPa was applied. Samples were taken as required for the individual tests. Results are given in table 1.

### EXAMPLE I

A product equal to the product of was Comparative Experiment A was produced with the only difference that the thickness of the sheet of aluminum 7039A was 0.5 mm.

### EXAMPLE II

A number of 390 unidirectional sheets comprising polyethylene fibers were stacked. On the two outer surfaces of this stack a woven fabric of E-glass of 250 gram/m² was placed; the woven fabric of E-glass was impregnated with a vinylester. On each of the two woven fabrics a sheet of aluminum 7039A of thickness 0.75 mm was positioned. The obtained stack of aluminum/woven fabric of E-glass/unidirectional sheets comprising polyethylene fibers/woven fabric of E-glass/aluminum was put in a press and pressed according the procedure for compressing unidirectional sheets as described above.

Samples were taken as required for the individual tests. Results are given in table 1.

### EXAMPLE III

A number of 390 unidirectional sheets comprising polyethylene fibers were stacked. On one of the two outer surfaces of this stack a woven fabric of E-glass of 250 gram/m² was placed; the woven fabric of E-glass was impregnated with a vinylester. On the woven fabric a sheet of aluminum 7039A of thickness 5 mm was positioned. The obtained stack of aluminum/woven fabric of E-glass/unidirectional sheets comprising polyethylene fibers was put in an oven and preheated during 1 hour at 100° C., followed by putting in a press and pressed in the same way as for Experiment II.

Samples were taken as required for the individual tests. Results are given in table 1.

### EXAMPLE IV

A 800 mm×115 mm composite panel comprising a 0.5 mm aluminium front plate bonded to a 8 mm compressed sheet comprising unidirectional sheets.

The composite panel passed the IMO FTP Codes 1998, Part 2: Smoke and toxicity test, including revision MSC/Circ. 1008 and the IMO FTP Resolution A.653(16) evaluated in accordance to Part 5 of Annex 1 of the IMO FTP Code for bulkhead, wall and ceiling linings.

### EXAMPLES V-X

A composite article was produced by building a stack of unidirectional sheets (UD). The sheets were stacked until the desired areal density was achieved, with additional layers of aluminum (Al), steel (Armox 500) or ceramic (C; type of ceramic was Al₂O₃) were added as necessary. The aluminum and steel were pretreated by sandpaper grinding and chemical etching with 8% wt. nitric acid to improve adhesion lateron to the UD. The stack was then transferred to a press and pressed at a temperature of 125° C. and a pressure of 16.5 MPa for 30 minutes, followed by cooling under pressure to 55° C.

Ballistic testing was performed using 20 mm (53.8 gram) fragment simulating projectiles (FSP) and 14.5 mm (64 gram) amour piercing (AP) projectiles. The composite articles were tested for ballistic performance by firing projectiles (FSP or AP) into the composite articles at a speed of between 916 m/s and 1147 m/s. A composite article was deemed to pass if the projectile with the mentioned velocity is stopped. A composite article was deemed to fail if the projectile penetrated the composite article at the mentioned velocity.

Examples IV & V highlight that the arrangement of the layers contribute towards the effectiveness of the composite, with the Al facing composite functioning as a better barrier to the FSP in comparison to the UD facing composite. The comparative experiments (B-D) indicate that neither 38 mm thick UD or Al was able to withstand the impact of a FSP with a velocity of 1065-1070 m/s. An increase in thickness of the Al sheet to 50 mm (comparative experiment D) was required for the sheet to effectively function.

The results highlight the synergistic effect of the composite material, which despite being thinner (24 mm Al+12 mm UD), than the monolayer structures in the comparative examples (38 mm), produced superior performance.

Examples VI &VII indicated that the Steel/UD composite, even at a thickness of 42 mm, was insufficient to withstand the impact of 14.5 mm AP projectiles. However, through the inclusion of a further ceramic layer, the composites became effective barriers against both FSP and AP projectiles. The inclusion of an 18 mm ceramic layer enables the composites (Examples VIII-X) to pass the ballistic testing against both FSP and AP projectiles with a lower areal density and thickness than compared to Example VII (Steel/UD composite).

TABLE 1

| Example/ | Flammability | | |
|---|---|---|---|
| Comp. Exp. | temperature | Toxicity index | Smoke index |
| A | FAIL | | |
| I | PASS | PASS | PASS |
| II | PASS | PASS | PASS |
| III | PASS | | PASS |

TABLE 2
IMO FTP Part 5 test results

| Test | Criteria | | Example IV | |
|---|---|---|---|---|
| Critical Flux at Extinguishment | ≧20 | kW/m² | >50.5 | kW/m² |
| Heat for sustained burning | ≧1.5 | MJ/m² | NC | |
| Total heat release | ≦0.7 | MJ | 0.1 | MJ |
| Peak heat release rate | ≦4.0 | kW | 0.1 | kW |

NC—not calculated when flame spread is less than 180 mm.

TABLE 3
Ballistic test results

| | | | | Areal | | | |
|---|---|---|---|---|---|---|---|
| | | | | Density | | Speed | |
| Ex/Exp# | Composite¹ | Thickness | | kg/m² | Projectile | m/s | Observation |
| IV | Al/UD | 24/12 | mm | 77 | FSP | 1050 | Pass |
| V | UD/Al | 12/24 | mm | 77 | FSP | 1041 | Fail |
| VI | Steel/UD | 24/12 | mm | 118 | AP | 924 | Fail |
| VII | Steel/UD | 24/18 | mm | 164 | AP | 916 | Fail |
| VIII | C/Steel/UD | 18/6/9 | mm | 124 | AP | 925 | Pass |
| IX | C/Steel/UD | 18/6/9 | mm | 124 | AP | 1074 | Pass |
| X | C/Steel/UD | 18/6/9 | mm | 124 | FSP | 1147 | Pass |
| B | UD | 38 | mm | 38 | FSP | 1066 | Fail |
| C | Al | 38 | mm | 103 | FSP | 1068 | Fail |
| D | Al | 50 | mm | 135 | FSP | 1050 | Pass |

¹The first ordered layer facing the ballistic threat.

1. Composite article comprising a metal sheet and at least two unidirectional sheets, whereby the thickness of the metal sheet is at least 0.25 mm, with the metal in the metal sheet having a melting point of at least 350° C., whereby the unidirectional sheets comprise at least 2 mono-layers of unidirectional oriented high performance fibers with the direction of the said fibers in a mono-layer is at an angle α to the direction of the fibers in an adjacent mono-layer.

2. Composite article according to claim 1, further comprising a binder.

3. Composite article according to claim 1 whereby the metal in the metal sheet is chosen from the group of aluminum, magnesium, titanium, nickel, chromium and iron or their alloys.

4. Composite article according to claim 1, whereby the composite article comprises at least 40 unidirectional sheets.

5. Composite article according to claim 1, whereby the fiber weight in the unidirectional sheets is between 10 and 250 g/m2.

6. Composite article according claim 1, whereby in the unidirectional sheets the amount of binder is at most 30 wt %.

7. Composite article according to claim 1, whereby the thickness of the metal sheet is at most 50 mm.

8. Composite article according to claim 1, whereby the high performance fibers in the unidirectional sheet have a tensile strength of at least 1.2 GPa and a tensile modulus of at least 40 GPa.

9. Composite article according to claim 1, whereby the whereby the high performance fiber is a polyolefin fiber, especially a polyethylene fiber, a polyvinyl alcohol fiber, a polyacrylonitrile fiber, an aromatic polyamide fiber, especially poly(1,4-p-phenylene teraphthalamide), a liquid crystalline polymer and ladder-like polymer fiber such as polybenzimidazole or polybenzoxazole, especially poly(1,4-phenylene-2,6-benzobisoxazole), or poly(2,6-diimidazo[4,5-b-4′,5′-e]pyridinyle-1,4-(2,5-dihydroxy)phenylene).

10. Composite article according to claim 1, the composite article having a weight of least 4.0 kglm².

11. Composite article according to claim 1, whereby a bonding layer is present between the metal sheet and the at least two unidirectional sheets, the bonding layer comprising a woven or non woven layer of inorganic fiber.

12. Composite article according to claim 1, whereby the surface of the metal sheet opposite to the metal surface facing the unidirectional sheets faces a ceramic layer.

13. Flame retardant composite article comprising a metal sheet of thickness of at least 0.25 mm and at least two unidirectional sheets, the flame retardant article having a flammability temperature of at least 200° C. according to ISO 4589-3.

14. Process for the manufacture of a composite article comprising the steps of stacking of at least 2 unidirectional sheets, each unidirectional sheet comprising monolayer sheets of unidirectional oriented high performance fibers whereby the direction of the high performance fibers in a monolayer sheet is at an angle α to the fiber direction in an adjacent monolayer sheet and a metal sheet of thickness of at least 0.25 mm and a melting point of at least 350 C, followed by consolidating the stacked sheets under temperature and pressure.

15. Use of the composite article of claim 1, in buildings and constructions, vehicles and ballistic applications.
